(19) United States
(12) Patent Application Publication
(10) Pub. No.: US 2014/0222530 A1
(43) Pub. Date: Aug. 7, 2014

(54) PROGRAM HAVING A CONSUMER VALUE SCORE

(71) Applicant: Triliant, LLC, Zionsville, IN (US)

(72) Inventors: Brian Wegner, Zionsville, IN (US); Ryan Wegner, Murrieta, CA (US)

(21) Appl. No.: 14/173,958

(22) Filed: Feb. 6, 2014

Related U.S. Application Data
(60) Provisional application No. 61/761,438, filed on Feb. 6, 2013.

(51) Int. Cl. G06Q 30/02

(52) U.S. Cl. CPC G06Q 30/0207
USPC 705/14.1

(57) ABSTRACT

A system 10 is provided for a multi-tenancy, vendor customer loyalty and marketing program that determines a customer's propensity to redeem a promotion. The system includes a software adapter executed by a data processor to retrieve consumer data over a wide area network. A consumer value score database server is provided including operational software and a plurality of consumer accounts. The database server is configured to store the consumer data, the database server is further configured to manipulate the consumer data for use in proprietary process to determine a consumer value score indicative of a consumer's promotion eligibility. The database server is operable to transmit the consumer value score to a promotion platform.

### CROSS-REFERENCE TO RELATED APPLICATIONS

The present application is a non-provisional utility patent application of and claiming priority to U.S. Provisional Patent Application No. 61/761,438, filed Feb. 6, 2014, and having the title PROGRAM HAVING CONSUMER VALUE SCORE, which is herein incorporated by reference.

### TECHNICAL FIELD OF THE DISCLOSURE

Generally, consumer marketing programs are based on a customer's purchase amount, transaction items, and/or status in the program. Loyalty programs are designed to provide customers with incentives for additional purchases. For example, a customer that frequently shops at a particular business may be provided with future promotions for the purchase of goods at that business. Such promotions are provided to facilitate repeat purchases, increases in market basket size, and frequent shopping by the customer at that business. Additionally, some promotion programs generate customer promotions to entice a consumer to shop at a new store or buy a new product. Other marketing program promotions are typically generated based on sales data such as the customer's previous purchases at other businesses. A customer who has a history of buying electronics may be provided promotions to various electronics businesses regardless of whether that consumer has shopped at such businesses in the past. These promotions entice consumers to shop at new businesses so that the consumer may become a regular customer at the new business.

Unfortunately, many promotion programs generate promotions that are irrelevant and go unused by the consumer. While basic demographic data and previous purchase data provide a starting point for generating a promotion, this data does not create a complete picture of what the consumer is likely to buy or how likely they are to respond to specific promotions or promotion types (i.e. electronics, baby products, dairy-based food products).

There remains a need for improvements in customer marketing and loyalty programs that will make them more effective in targeting consumer's needs on a more personalized level.

### SUMMARY OF THE DISCLOSED EMBODIMENTS

In some embodiments, a system is provided that is based on a back-end technology platform that allows merchants, consumer packaged goods companies (CPG's), loyalty solution providers, and other businesses, developers and third parties to access the system in order to support the back-end solution consumer scoring, processing, messaging, promotion creation, eligibility decisioning, and/or program and member management. The system components may include data storage repositories, analytics and data models, mathematical processes, web and application services and servers, and marketing promotion facilities, integration and connection points (i.e. application program interfaces, software development kits) for third party businesses and developers, web-based user interfaces, a rules engine system, and an analytic marketing platform.

In some embodiments, the solution platform includes mathematical processes for the calculation of consumer promotion-worthiness scores by defined categories to establish which promotions and rewards each consumer will receive. Retailers, CPG's, loyalty and marketing program providers, and other third parties will supply data to and access the system to use the consumer worthiness score system and scoring to determine (a) whether to present discounts and marketing promotions to each consumer, (b) the type and value of promotions to present to each consumer, and (c) the time and manner (i.e. delivery channel mediums) in which to present the promotion to each consumer. Consumer promotions would be predicated on their associated consumer worthiness score, with high-scoring consumers receiving more valuable promotions than low scoring consumers (like a “credit score” for loyalty rewards and promotional marketing promotions).

In some embodiments, the system provides a repository to house consumer data, business data, third party information, and desired goods and services (items), in various forms, to which consumers may post items and/or desired promotions or rewards for those items. Postings submitted by consumers may be in the form of a product identification code, a picture, a description, or other form. The postings may be made via a web interface, a mobile device, or the like. The system will receive these postings to 1) pass them to merchants and CPG's for potential promotion creation and delivery to targeted consumers, 2) search the system for coupons, promotions, or other promotions for the product/service, 3) generate the promotions and deliver them directly to the consumer via a mobile device, a web interface, email, or any combination of the above. Both the scores and the data repositories are available as a service to businesses, loyalty program/marketing promotion providers, and other third parties to use in determining which promotions to present to which consumers, how to deliver them, and when to provide those promotions. Access to the repository and scores may occur through a batch background process to support the pushing of promotions to consumers, or in a real-time background process to support the ability to (a) post a request while shopping (online or in person) and enable businesses to respond immediately based on the business's desire driven by the consumer's score for the relevant category(ies) and request, or (b) for consumers who “check in” to a business to be identified by that business, and for that business to immediately determine and present appropriate unsolicited promotions to the consumer based on that consumer's score for the relevant category(ies).

Further, in some embodiments, the system provides for the matching of items into defined categories in the repository from which businesses may obtain consumer requests for items, and a facility through which responses may be delivered back to the consumer, or the loyalty program/marketing promotion provider.

Further, in some embodiments, the system provides a database and system that captures and stores multiple consumer level elements (consumer data), including product level purchase data, demographic information, credit information, and other data used to (a) calculate the consumers' scores across various categories, and (b) facilitate the process of determining which promotions to make to which consumers and when to make those promotions. The system will also provide functionality to support location-based promotions, where consumers are presented with promotions and rewards for businesses within their proximity, as well as to enable store clerks who are interacting with customers to utilize a web-based application to create (for the consumer) or accept (from the consumer) real-time promotional promotions on demand.

In some embodiments, the mechanism for calculating the consumer worthiness score includes a system into which the consumer data is fed, specialized analytics that determine the relative value of each attribute, and output of a score that fits into a scale, such as a scale of 0 to 1,000, for an unlimited number of defined categories. For example, categories may be comprised of baby items (for which a 22 year old single male may have a low score), high-end electronics, and more. Categories may address specific products such as these, or lifestyle attributes that may be referenced to determine which promotions to make (such as a person that is an early adopter of technology). Categories may exist at a parent level with sub categories (such as restaurants, further defined as fast food, quick serve, upscale, etc). Consumer scores are recalculated periodically to accurately reflect changes in economic condition, behaviors, and other factors.

Other embodiments are also disclosed.

### BRIEF DESCRIPTION OF THE DRAWINGS

The embodiments described herein and other features, advantages and disclosures contained herein, and the manner of attaining them, will become apparent and the present disclosure will be better understood by reference to the following description of various exemplary embodiments of the present disclosure taken in conjunction with the accompanying drawing, wherein:

FIG. 1 is a flowchart for a multi-vendor customer loyalty and marketing utility that generates and utilizes a consumer value score, according to one embodiment.

FIG. 2 illustrates a chart utilized to determine a factor score, according to one embodiment.

FIG. 3 illustrates a chart utilized to determine a factor score, according to one embodiment.

FIG. 4 illustrates a chart utilized to determine a consumer value score, according to one embodiment.

FIG. 5 illustrates a chart utilized to determine a consumer value score, according to one embodiment.

### DETAILED DESCRIPTION OF THE DRAWINGS

Data for customer loyalty and/or marketing programs fails to recognize the financial constraints of the consumer. While the consumer may have a history of purchasing electronics, the consumer may not have the financial capability of redeeming a reward or promotion for a discount on a purchase of $2000 or more. Conversely, some consumers may not take the time to redeem a reward for five dollars off a product purchase price.

Additionally, current promotion systems do not account for the consumer's desired purchases. While the consumer may have a history of purchasing electronics, the consumer may not be in the market for new electronics at the time the promotion is made. Rather, the consumer may be in the market for furniture. Current loyalty programs do not provide the consumer with the ability to create their own requests for promotions for products that the consumer is currently in the market for. Further, a business's inability to provide a promotion while the customer is in the store or after the customer has shown interest in a product may limit that business's ability to sell a product to a consumer, thereby limiting good will for future products.

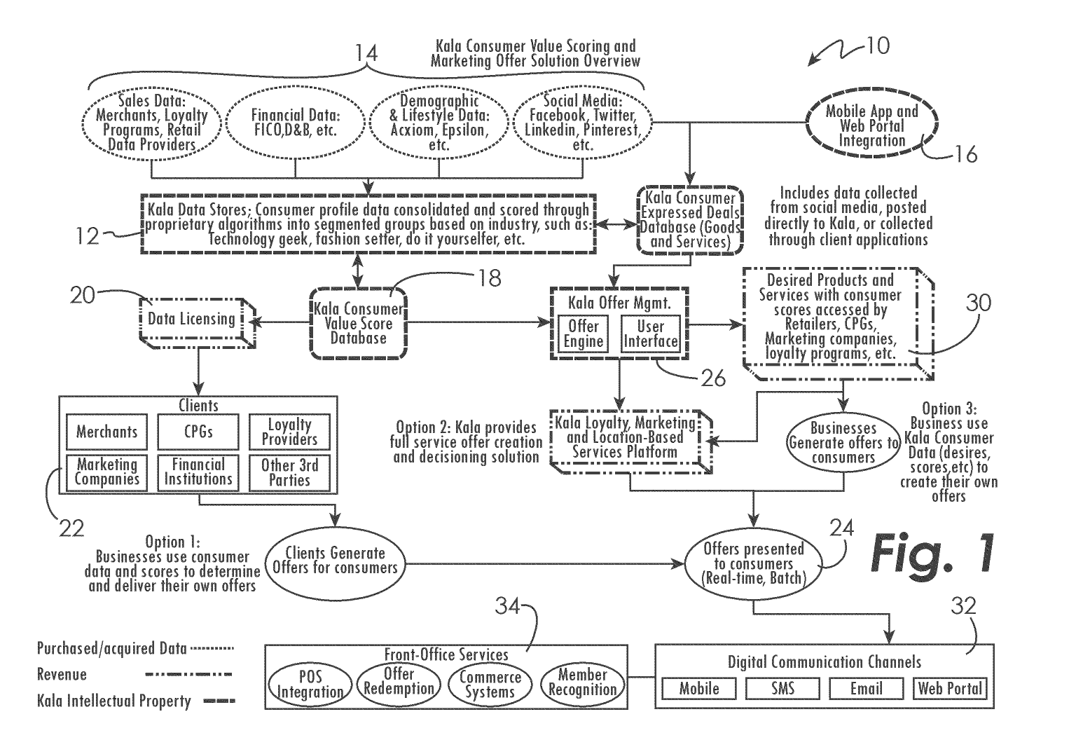

Another drawback to current programs is the inability of the business to determine “consumer worthiness”. It is common for a consumer to ask for discounts on various items. Some businesses are willing to provide such discounts to achieve the loyalty of the consumer and ensure future purchases. However, some consumers are unlikely to return to a particular business even after receiving a discount. Businesses are often unable to determine the long-term value and worthiness of any particular customer. As a result, businesses are reluctant to provide discounts without being able to gauge the likelihood of repeat business. A system 10 for a multi-vendor customer loyalty program is illustrated in FIG. 1.

For the purposes of promoting an understanding of the principles of the present disclosure, reference will now be made to the embodiments illustrated in the drawing, and specific language will be used to describe the same. It should be appreciated that not all of the features of the components of the figures are necessarily described. Some of these non-discussed features, as well as discussed features are inherent from the figures. Other non-discussed features may be inherent in the system configuration. A consumer may include an individual, a business, or other entity. It will nevertheless be understood that no limitation of the scope of this disclosure is thereby intended.

The present embodiments include a system 10 for a multi-vendor consumer value scoring program that determines a customer's propensity to redeem a promotion and value for promotions and rewards. By creating a consumer account, the consumer obtains access to the system 10 to receive various promotions and promotions. Additionally, the consumer has the capability to upload information related to products in which the consumer is interested. Businesses likewise have access to the system 10 through vendor accounts. Businesses may use the system 10 to generate their own promotions, review consumer worthiness, and/or upload consumer data related to the consumer's previous purchases.

The system 10 includes a software adapter 12 executed by a data processor to retrieve promotion related data over a wide area network. The consumer profile data 14 may include consumer data, business or sales data, third party information, and/or desired goods and services data which is stored in a repository in various electronic forms. The business or sales data includes data obtained from vendors, for example merchants or manufactures. This data includes information related to a particular consumer's previous purchases. The data may include product identification codes or product descriptions of the consumer's previous purchases. Additionally, data related to a consumer's use of a retailer loyalty program may also be housed with the business or sales data. In one embodiment, vendors may provide information related to products that the vendor desires to sell in the near future. In yet another embodiment, the system 10 may be adapted to collect data related to healthcare and education. This data may be utilized to provide promotions on healthcare and educational products and services, for example prescriptions, medication, text books, health services such as spa treatments and chiropractic treatments, or educational services such as study groups, continuing education classes, and the like.

The consumer data generally consists of demographic and lifestyle information related to a particular consumer. In one embodiment, the software adaptor retrieves this information from services such as ACXIOM, EPSILON, or the like. The system 10 may further scrub social media outlets to obtain additional consumer demographic information. The consumer may additionally provide data by accessing their account through the system 10. Additionally, the consumer may upload data related to their health status and/or needs for continuing education. Consumer financial information is also retrieved by the system 10. For example, the system 10 may retrieve credit reports or other financial data such as Fair Isaac Corp. and/or Dun & Bradstreet reports.

Desired goods and services data is retrieved by the system 10 through social media outlets. A consumer links their social media outlets to the system 10 to allow the system 10 to scrub the social media outlets for consumer data. Additionally, the consumer may upload desired goods and services data to the social media outlet by posting product identifiers such as product identification codes, product pictures, product descriptions, or the like. A data processor receives the desired goods and service data and passes the data to merchants and consumer packaged goods companies where the consumer is a member for potential promotion creation and delivery. The data processor further searches the system 10 for coupons or promotions for the desired product and/or service. In one embodiment, the system 10 generates the promotions and delivers them directly to the consumer via a mobile device, the web or email 16.

A consumer value score database server 18 compiles and manipulates all of the consumer profile data 14 to create a consumer profile having a consumer value score. The system 10 utilizes specialized analytics that determine a relative value of each attribute (sales data, financial data, demographic and lifestyle data, and social media or desired goods and services data) to output of a score that fits into a scale, such as a scale of 0 to 1,000 for example, for an unlimited number of defined categories. The system 10 consolidates and scores the data through segmented consumer groups based on industries, such as technology geek, fashion setter, do it yourselfer, etc. Product categories may include baby items (for which a 22 year old single male may have a low score), or high-end electronics, etc., to name just two non-limiting examples. Product categories and consumer groups may exist at a parent level with subcategories (such as parent product category “restaurants,” further defined as subcategories fast food, quick serve, upscale, etc.). Consumer scores are recalculated periodically to accurately reflect changes in economic condition, behaviors, and other factors.

Both the scores and the data repositories are available as a service to businesses, loyalty program/marketing promotion providers, and other third parties to use in determining which promotions to present to which consumers, how to deliver them, and when to provide those promotions. For example, a consumer may have a history of purchasing electronics, has economic means for continued purchases, and other factors that would therefore result in a high electronics score. However, the score may vary based on the other consumer profile data 14. In particular, a consumer having a low credit score would have a lower electronics score indicative that the consumer would not likely make an expensive purchase. Other data may indicate that while the consumer enjoys electronics, a promotion to the consumer may not result in repeat business. Conversely, a consumer having a high probability of purchasing electronics coupled with a high credit score may indicate that the consumer is likely to spend more money more frequently. Accordingly, the consumer may have a very high electronics score, thereby making the consumer worthy of more frequent and higher cost promotions.

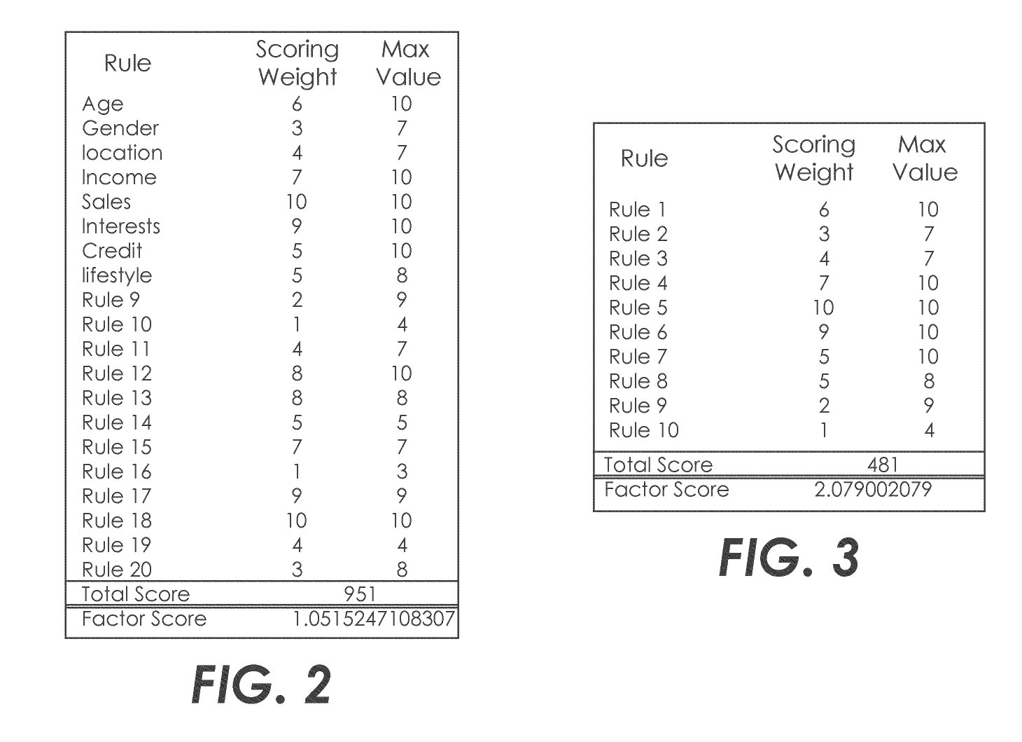

An example of a process used to determine whether a consumer is likely to purchase electronics is provided in FIGS. 2-5. First a plurality of rules are weighted. The rules utilized in the process, as well as the weight values, depend on the type of good or service to be evaluated. Some examples of rules and their weights for electronics products are provided below. In one embodiment, the rules utilized in the process and the weights applied to each rule will vary based on a category of the promotion. Additionally, the maximum scores and factor scores will likewise vary. For example, an “electronics score”, i.e. a score for determining promotions for electronics, may have different rules and scoring weights than a “fashion setter score”, i.e. a score for determining promotions for clothing and accessories.

Age=weight of 6
Band of 16 to 24=value of 8
Band of 25 to 32=value of 9
Band of 33 to 39=value of 10
Band of 40 to 50=value of 9
Band of 51 to 59=value of 7
Band of 60 to 74=value of 5
Band of 75+=value of 3

Gender=weight of 3
Male=value of 7
Female=value of 5

Location=weight of 4
Rural=value of 4
Suburban=value of 7
City=value of 6

Income data=weight of 7
$0 to $20K=value of 1
$20K to $29K=value of 3
$30K to $45K=value of 4
$46K to $65K=value of 6
$66K to $80K=value of 8
$81K to $125K=value of 9
$126 to $200K=value of 10
$200K=value of 9

Sales data=weight of 10
Purchased less than 3 electronics products in last 12 months=value of 2
Purchased between 3 and 5 electronics products in last 12 months=value of 4
Purchased between 5 and 10 electronics products in last 12 months=value of 7
Purchased more than 10 electronics products in last 12 months=value of 10

Interests=weight of 9
Stated interest in electronics products, but not on product discounts=value of 5
Stated interest in electronics products, and for product discounts=value of 10
No interest in electronics products or product discounts=value of 0

Credit data=weight of 5
Credit score less than 500=value of 1
Credit score between 500 and 600=value of 3
Credit score between 600 and 650=value of 6
Credit score between 650 and 700=value of 8
Credit score between 700 and 800=value of 9
Credit score above 800=value of 10

Lifestyle=weight of 5
Home owner: if yes, value=8; if no, value=7
Young family: if yes, value=4; if no, value=6
Single: if yes, value=8; if no, value=5

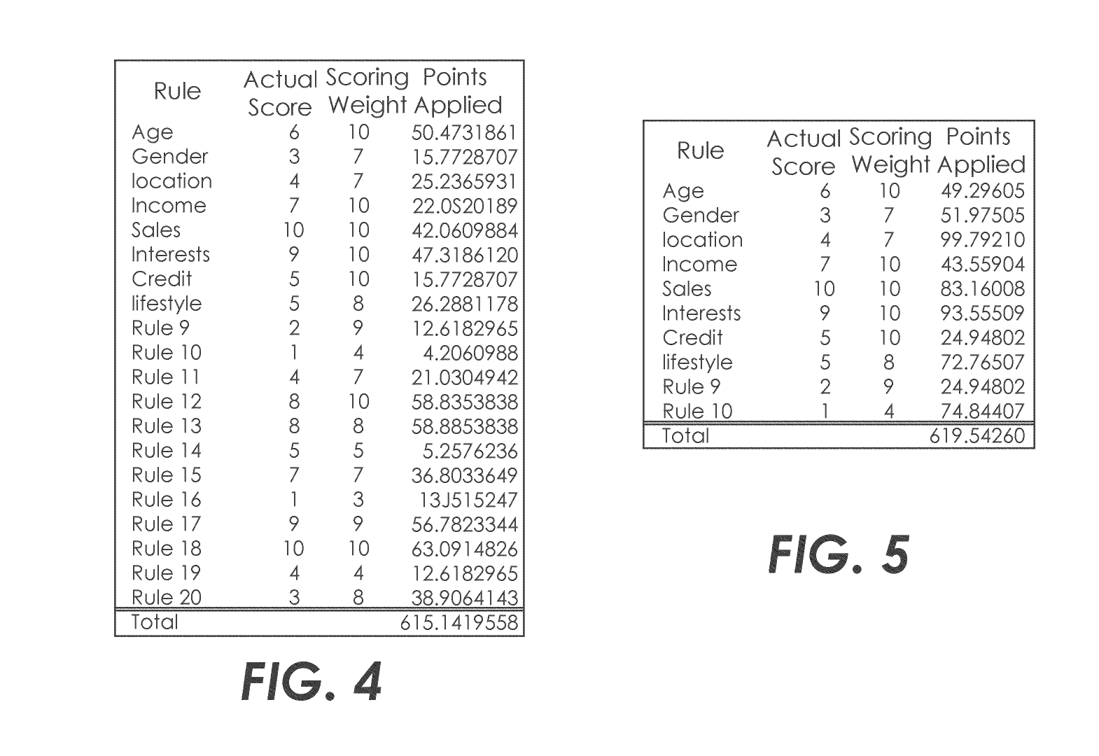

A Factor Score is first determined for each collection of rules. For each rule within the collection, a weight and a Maximum Value (the maximum of the values assigned to each rule) is determined. Each Maximum Value is multiplied by the corresponding weight to determine a score for each rule, and these scores are summed to determine a Total Score. The process then divides “1000” (the defined maximum possible Total Score) by the Total Score determined for the collection of rules to determine the Factor Score. FIG. 2 illustrates an example utilizing 20 rules, whereas, FIG. 3 illustrates an example utilizing 10 rules. The process performs one or more database lookups to obtain information about the individual being scored and to determine the rule conditions satisfied for each individual being scored. The process then assigns values based on the rule conditions as applied to the information known about the individual. Once the values are determined, the process multiples the value by the weight associated with the rule, then multiples that product by the Factor Score for this collection of rules. This determines the points for each indicator (rule), as illustrated in FIGS. 4 and 5. The points are then summed to get the final consumer value score. It will be appreciated that the above scoring methodology is provided as a non-limiting example. Those skilled in the art will recognize in view of the present disclosure that any number of scoring methodologies may be employed that take into account various rules, weights and values as they apply to specific demographic aspects of the individual being scored.

The consumer value score is between 1 and 1000 in this example. 1000 therefore represents the highest estimated likelihood of responding to an overture by the retailer, which could be in the form of a promotion or some other outreach by the retailer. Retailers have the flexibility to set their own thresholds to send promotions depending on their own defined constraints. For example, if a local organic grocer was trying to reach 50,000 high value people in the Chicago/Milwaukee market, the average score for those 50,000 people identified would be lower than an electronics company looking to reach 10,000 people across the nation with high propensities to buy tablet computers. This is due to the more limited market for organic food and the smaller population. In one embodiment, a score of 500 would indicate that the individual is no more or less likely than the “average” person to respond, while a score of 800 would indicate that the person is in the 20th percentile of individuals most likely to respond.

In one embodiment, the system 10 provides three options for consumers to receive promotions through promotion platforms. The first option is to receive the promotion through a data licensing platform 20. The data licensing platform 20 is accessed by subscribed and licensed businesses 22 to retrieve the consumer data and score. These subscribed businesses may include merchants, consumer product goods companies, loyalty providers, marketing companies, financial institutions, or other third parties. The consumer data and score is retrieved by these companies so that the company may generate promotions 24 on their own utilizing the data and consumer value score. These promotions 24 are then sent directly to the consumer by the subscribed business. For example, an electronics merchant may receive data and a score for a consumer having a high electronics score. The electronics merchant may then prepare a promotion to be sent directly to the consumer based on the data and score. Conversely, the electronics merchant may disregard a consumer having a low electronics score and/or provide that consumer with a lesser promotion or no promotion at all.

For the first option, the business client interacts with the system 10 using their merchant portal (user interface) and selects the scoring categories they are interested in utilizing to determine promotions. The user interface is connected to a backend scoring database dedicated specifically to the consumer value scoring utility. The database contains scoring categories, individual consumer scores across all categories, and associated consumer data. Once the business selects the categories they want (i.e. electronics, women's fashion, fast food junkie, etc.), other demographics like consumer location (global, national, regional, state, county, etc.) and the percentile (i.e., top 10% of consumers), the database retrieves the associated records and delivers them to the business electronically. Once the business has these records (scoring categories with associated scores for each consumer, customer demographics for contacting like email, name, etc.), they define their own promotions and send them to the consumers.

The second and third options utilize a promotion management database 26 that is operated through the system 10. The promotion management database 26 stores data on previous or existing promotions and business data related to promotions that businesses have considered or authorized. A consumer deals database, including data collected from social media, posted directly to the system 10 or collected through client applications, is linked to the promotion management database 26 to provide additional data. The promotion management database 26 further communicates with the consumer value score database to retrieve consumer scores. The database 26 includes operational software to generate promotions through analytics that manipulate the data and consumer score to create promotions having a high likelihood of being redeemed, thereby improving the success rate of the promotions.

Under the second option, the promotion management database 26 sends promotions directly to the consumer through a mobile device, a web portal, or the like 32. The promotions may be for businesses or products that the consumer has a history of purchasing. Alternatively, the promotions may be for products that match the consumer's profile and are sent to the consumer to entice the consumer into shopping at new businesses or purchasing new products. The consumer value score is utilized to determine an amount of the promotion and/or an overall purchase price for the promotion. In one embodiment, the promotions are related to business loyalty programs of which the consumer is a member. The promotions may also be related to products that the consumer has shown an interest in through social media postings.

Under the third option, the promotions are generated by a business based upon a consumer's interest level 30 in a product. For example, a consumer at an electronics store may be interested in purchasing a particular television. Upon the consumer's inquiry about a discount, the business utilizes the system 10 to determine whether a current promotion exists or whether a promotion can be made. In particular, the system 10 provides for the matching of items into defined categories in the repository from which businesses may obtain consumer requests for items, and a facility through which responses may be delivered back to the consumer, or the loyalty program/marketing promotion provider. The determination is based upon the consumer's score. For example, a consumer with a high score may be entitled to a greater percentage off the product. This is determined by the score's indication that the consumer is likely to make large purchases again in the future. Conversely, a consumer with a low score may be provided with a lesser promotion or no promotion at all as it is unlikely that the consumer will make more large purchases in the future.

Access to the repository and scores may occur through a batch background process to support the pushing of promotions to consumers, or in a real-time background process to support the ability to post a request while shopping (online or in person) and enable businesses to respond immediately based on the business's desire, driven by the consumer's score for the relevant category and request, or for consumers who “check in” to a business to be identified by that business, and for that business to immediately determine and present appropriate unsolicited promotions to the consumer based on that consumer's score for the relevant category. The system 10 also provides functionality to support location-based promotions, where consumers are presented with promotions and rewards for businesses within their proximity, as well as to enable store clerks 34 who are interacting with customers to utilize a web-based application to create real-time promotional promotions on demand.

The promotions are sent to the consumer's mobile device or web portal through text or email, for example. The consumer may redeem the promotions at the point of sale by printing them or through the mobile device, i.e. scanning a bar code on the mobile device. At the point of sale, the business is integrated to the system 10 through an integration and connection terminal so that the promotion may be redeemed by the system 10 recognizing the consumer or the business as a member of the system 10. For example, the business may log onto the system 10 through the terminal and the customer may log on through a password, account number, bar code on their mobile device, or by any other appropriate manner. The promotion is then redeemed at the terminal and the redemption is delivered to the system 10 and tracked. In one embodiment, the system 10 allows ad hoc, real time retrieval of a specific Consumer's Value Score at the point of sale to help the vendor determine whether and to what degree to offer a special promotion at that time.

In one embodiment, the promotions may be sent through a mobile application that is downloadable to a mobile device. The mobile application allows the consumer to receive promotions, as well as, access the system 10 to edit a consumer profile, wherein the consumer profile may include bibliographic data related to the consumer and/or data related to desired promotions and/or an interest in a particular purchase. Furthermore, the system will allow the consumer to upload items of interest such as specific products and promotion types to the Consumer Expressed Deals Database, where the system will match their requests to existing offers or create new offers for the consumer.

In one embodiment, the system 10 combines the consumer scoring process with the promotion management system 26. These promotions are defined with variable inputs for things like monetary value off or percentage of monetary value off, which are determined based on the consumer value score for a given category. The system 26 takes the electronics scores for each consumer, their demographics, and rank them based on their associated percentiles (weeding out any consumers who do not fit the profile). The system 26 then determines the monetary and percentage values depending on the consumer ranking. Accordingly, people in the top 10 percentile might get a promotion of 20% off a transaction greater than $125, while people in the 20^{th} percentile might get 15% off a transaction greater than $100. Once the promotions are generated, they are written back to the transactional database and linked to a consumer via their member ID.

In another embodiment, a business may use a special interface to do a lookup and obtain the consumer's value score for a particular category. The business then predefines what promotions a consumer is eligible for based on their consumer value scores in a category or across categories, which would show up in the user interface when a store associate enters the input parameters (consumer identifier). So for some businesses, people with electronics scores less than 500 may not be eligible for any promotions, while consumers with scores between 800 and 900 with residence in the state of California may be eligible for certain deals. Selecting a deal generates a promotion code and assigns that promotion to the member's account (which can be redeemed immediately at the point of sale).

Although the current embodiments are described with respect to retail services, it should be noted that the system 10 may also be adapted for additional industries, such as healthcare and education. In such an embodiment, the system 10 would collect additional data, for example, healthcare data related to the consumer's prescription and medication purchases, health history and the like. With respect to education, information related to a consumer's field of study or education related purchases may also be collected by the system 10. This data is factored into the consumer value score. The scoring and the analytics would be expanded to include additional categories, wherein the additional categories include healthcare and/or educational products and/or services. Accordingly, the system 10 would provide insights into the needs and propensities of individuals related to education and healthcare. The consumer score may then be sent to businesses such as doctors, chiropractic services, spa services, pharmacies, continuing education services, or other similar business so that these businesses may generate promotions or recommended programs based on the consumer's score. In another embodiment, the system 10 may generate promotions for healthcare and education services and deliver these promotions to the consumer directly. Additionally, the businesses may utilize the system 10 to determine the best promotion or discount to provide to a customer at the time the customer is seeking a service.

In one embodiment, the system 10 also includes a predictive analytics server that predicts a future consumer value score at a future point or points in time. The predictive analytics server compiles information about the consumer and utilizes the information to predict a future score of the consumer. For example, the server may assess information related to the consumer's recent income change or home mortgage loan. This information may then be utilized along with the current consumer data and patterns learned from other similar customers to predict a path of the consumer. In one embodiment, the predictive analysis takes the consumer information, such as consumer demographics, value scores, social media info, transaction histories, etc., and utilizes data mining models to determine a predictive score. Such data mining models may include, but are not limited to regression modeling, link analysis, and segmentation. The data mining models are utilized to analyze historical data patterns to determine the purchasing habits of other similar consumers and use those data inputs to predict how the purchasing habits of a current consumer will evolve over time.

As an example, the consumer may have a low consumer score because the consumer has been in medical school and has had limited finances. However, this consumer may be projected to graduate from medical school within six months. Additionally, the collected consumer data may indicate that the consumer has accepted a position as a resident at a hospital with a high level of income. Given these future events, the predictive analytics server compares the consumer's score to other consumers who have recently graduated medical school. The system 10 then analyzes the purchasing habits of these other consumers to develop a future consumer value score. Accordingly, while a particular consumer may score low for electronics in the present, the predictive analytics server may project that the consumer is likely to be a valuable consumer in the electronics market in the future. By way of another example, an individual who traditionally scores low for furniture and home goods may purchase a new home. Based on this information, the predictive analytics server could project the consumer as a potential furniture buyer in the future.

While the embodiments have been illustrated and described in detail in the drawings and foregoing description, the same is to be considered as illustrative and not restrictive in character, it being understood that only certain embodiments have been shown and described and that all changes and modifications that come within the spirit of the embodiments are desired to be protected.

1-21. (canceled)

22. A computerized method for calculating consumer marketing worthiness scores for sales and marketing promotions of consumer products, product types, and businesses, the method comprising:
receiving a plurality of profile data over a computer network at a server, each profile data being related to a consumer;
creating a plurality of rules in a database, each rule comprising a product type, a weight and an analytic scorecard for each profile data, the analytic scorecard comprising a likelihood of responding to an offer type and purchasing a product corresponding to one or more ranges into which the profile data may fall;
determining with the server a confidence level of the consumer making a future purchase of the product or the product type by evaluating the plurality of profile data and the corresponding plurality of rules; and
sending a promotional offer to the consumer based on the confidence level and the profile data for the consumer.

23. The method of claim 22, wherein the promotional offer comprises a value and a type, the value and the type being determined based on a ranking of the consumer against other consumers for the product and product type.

24. The method of claim 22, wherein each profile data is selected from the group consisting of: purchase history, product interest, lifestyle attributes, personal preferences, social media profiles, health information, demographics, and financial data.

25. The method of claim 22, wherein the promotional offer comprises at least one of a mobile push notification, an email, an SMS message, a web portal message or alert, and a social media message.

26. The method of claim 22, wherein the promotional offer comprises at least one of a coupon, points redeemable for purchase of products or services, and an offer that may be redeemed for a cash value.

27. The method of claim 22, wherein the receiving step comprises scraping content on one or more social media outlets.

28. The method of claim 22, wherein the confidence level is determined by associating the weight with a score in the analytic scorecard for each rule, the score being associated with which of the one or more ranges the corresponding profile data falls.

29. The method of claim 22, wherein the promotional offer comprises a greater incentive for the product or product type when the confidence level is above a threshold and a lower incentive for the product when the confidence level is below the threshold.

30. The method of claim 22, further comprising repeating the determining step at one or more intervals.

31. The method of claim 22, wherein the profile data related to a customer comprises at least one of the purchase history of the customer, financial information of the customer, and health information.

32. A system for calculating consumer marketing worthiness scores for sales and marketing promotions of consumer products, product types, and businesses, the system comprising:
a server, the server configured to receive a plurality of profile data, each profile data being related to a consumer;
a database configured to store a plurality of rules, each rule comprising a product type or lifestyle attribute, weight and an analytic scorecard for each profile data, the analytic scorecard comprising a likelihood of responding to an offer of the product or product type corresponding to one or more ranges into which the profile data may fall;
wherein the server is further configured to determine a confidence level of the consumer making a future purchase of the product or the product type by evaluating the plurality of profile data and the corresponding plurality of rules, and send a promotional offer to the consumer based on the confidence level and profile data.

33. The system of claim 32, wherein each profile data is selected from the group consisting of: purchase history, product interests, personal preferences, lifestyle attributes, demographics, social media profiles, health information and financial data.

34. The system of claim 32, wherein the server is further configured to send the advertisement as at least one of an email, a push notification, a SMS, and a web portal message.

35. The system of claim 32, wherein the promotional offer comprises a redemption directed to a point of sale terminal.

36. The system of claim 32, wherein the server is further configured to send the promotional offer as a coupon.

37. The system of claim 32, wherein the server is further configured to retrieve the plurality of profile data by scraping content on one or more social media outlets.

38. The system of claim 32, wherein the confidence level is determined by associating the weight with a score in the analytic scorecard for each rule, the score being associated with which of the one or more ranges the corresponding profile data falls.

39. The system of claim 32 wherein the promotional offer comprises a greater incentive for the product or product type when the confidence level is above a threshold and a lower incentive for the product when the confidence level is below the threshold.

40. The system of claim 32, wherein the plurality of rules are based on the product types and the lifestyle attributes.

41. The system of claim 32, wherein the profile data related to a customer includes the purchase history of the customer.

42. A system for calculating consumer marketing worthiness scores for sales and marketing promotions of consumer products, product types, and businesses, the system comprising:
a database configured to store a plurality of profile data associated with a consumer, a plurality of rules, each rule comprising a product type, a weight and an analytic scorecard for each profile data, the analytic scorecard being a likelihood for responding to an offer for products of the product type based on one or more ranges of the profile data; and
a web server associated with the database and accessible by at least one end user, the web server configured to present to the at least one end user a merchant portal that, when rendered in a browser, is adapted to enable the end user to select at least one rule from the plurality of rules, and to determine a confidence level for the consumer related to the product type by evaluating the plurality of profile data against the at least one selected rule, and send a promotional offer to the consumer for a product based on the confidence level, the product being of the product type.

43. The system of claim 42, wherein each profile data is selected from the group consisting of: purchase history, product interest, demographics, and financial data.

44. The system of claim 42, wherein the server is further configured to send the promotional offer as at least one of an email, SMS, push notification, and web page alert.

45. The system of claim 42, wherein the server is further configured to send the promotional offer as a coupon.

47. The system of claim 42, wherein the server is further configured to retrieve the plurality of profile data by scraping content on one or more social media outlets.

48. The system of claim 42, wherein the server is further configured to determine the confidence level by associating the weight with a score in the analytic scorecard for each rule, the score being associated with which of the one or more ranges the corresponding profile data falls.

49. The system of claim 42, wherein the advertisement comprises a greater incentive for the product when the confidence level is above a threshold and a lower incentive for the product when the confidence level is below the threshold.

50. A system for receiving and matching consumer expressed offers, the system comprising:
a database configured to store a plurality of available offers and a plurality of consumer expressed offers and consumer profile data, each available offer comprising a product, an incentive amount, and an expiration time, each consumer expressed offer comprising a product, an incentive amount, and an expiration time;
a web server associated with the database and accessible by one or more consumers, the web server configured to facilitate a web portal and mobile application that, when rendered in a browser or mobile device, enables the one or more consumers to upload one or more consumer expressed offers to store in the database; and
a server associated with the database, the server configured to match the consumer expressed offers to available offers based on a plurality of rules.

51. The system of claim 50, wherein the server is further configured to calculate a confidence level for each consumer and each consumer expressed offer based on the corresponding consumer profile data and product.

52. The system of claim 51, wherein the web server is further configured facilitate a web portal that, when rendered in a web browser, presents a business intelligence, the business intelligence comprising each of the consumer expressed offers and each confidence level.

52. The system of claim 50, wherein the web portal is further configured to enable a business user to create and deliver offers directly to one or more of the plurality of consumers based on the business intelligence.
